(19) United States
(12) Patent Application Publication
(10) Pub. No.: US 2011/0095685 A1
(43) Pub. Date: Apr. 28, 2011

(54) Quick-start Type Fluorescent Lamp

(76) Inventor: Onn Fah FOO, Hong Kong (CN)

(21) Appl. No.: 12/605,371

(22) Filed: Oct. 25, 2009

(51) Int. Cl. H01J 61/20

(52) U.S. Cl. 313/641

(57) ABSTRACT

A quick-start type fluorescent lamp that includes a discharge envelope, which encloses a discharge space containing a filing of mercury and an inert gas in a gastight manner and includes tubular end portions each having a longitudinal axis, and electrodes being arranged in the discharge space for generating and maintaining a discharge therein, characterized in that: a Bi—In—Sn—Hg compound or Bi—In—Sn—Hg compound in combination with a Bi—In—Sn compound being free of mercury is disposed at one or two positions near the electrode. The quick-start type fluorescent lamp of the present invention has a much shorter starting time.

### TECHNICAL FIELD

The present invention relates to a low-pressure discharge lamp, and more particularly to a quick-start type fluorescent lamp.

### BACKGROUND OF THE INVENTION

It is well known that a fluorescent lamp is a low-pressure mercury vapor gas discharge device, from which visible light is produced when the phosphor layer coated on the inner surface of a hermetically sealed tubular glass envelope is excited by the ultraviolet radiation generated by an electric current flowing through a mercury vapor gas discharge formed within the tubular glass envelope when a proper electrical power is applied thereto. The light output parameters of fluorescent lamps, such as the starting time, the initial radiation output and the like, are critically dependent on mercury vapor pressure within the envelope. The mercury vapor pressure, in turn, will depend on the temperature of excess liquid mercury which condenses in the coldest part of the lamp envelope. While a predetermined vapor pressure is desirable for efficient operation of the lamp, amalgam has often been used to control the mercury vapor pressure therewithin, whereby permitting the lamp to operate more efficiently. However, the known lamp configurations with amalgam disposed in the lamp envelope have a comparatively low mercury-vapor pressure at room temperature. As a result, the known lamps have the disadvantage that the initial radiation output is comparatively low when a customary power supply is used to operate the lamps. In addition, the starting time is comparatively long because the mercury vapor pressure increases only slowly after ignition of the lamp. In this way, the known lamps are not able to meet the requirements of making the starting time as shortened as possible and enhancing the initial radiation output. Presently, no known solution to the problem is satisfactory.

Accordingly, there is a need for a new solution for improving the light output parameters of the fluorescent lamp.

### SUMMARY OF THE INVENTION

An object of the present invention is to provide a quick-start type fluorescent lamp, which could at least partly solve the problems of the prior art and exhibits good light output characteristic.

The problems of the prior art could be solved, at least in part, through the use of various amalgams and an alloy free of mercury and capable of absorbing mercury from its gaseous phase, wherein the amalgams might be selectively disposed at a plurality of arbitrary locations within the lamp envelope and it might also be applied in combination with the alloy disposed at various locations to amalgamate with the excess mercury and to regulate the mercury vapor pressure within the lamp envelope.

According to the present invention, the quick-start type fluorescent lamp might comprise:

a discharge envelope, which encloses a discharge space containing a filing of mercury and an inert gas in a gastight manner and includes tubular end portions each having a longitudinal axis, and electrodes being arranged in the discharge space for generating and maintaining a discharge therein, characterized in that:

a bismuth-indium-stannum-mercury (Bi—In—Sn—Hg) compound or a Bi—In—Sn—Hg compound in combination with a bismuth-indium-stannum (Bi—In—Sn) compound being free of mercury is disposed at one or two positions near the electrodes.

According to an embodiment of the present invention, the Bi—In—Sn—Hg compound might be disposed near both of the electrodes, which comprises a bismuth content in the range of 57.5 wt % to 63.5 wt %, an indium content in the range of 27.0 wt % to 33.0 wt %, a stannum content in the range of 4.4 wt % to 5.6 wt %, and a mercury content in the range of 4.0 wt % to 5.0 wt %.

According to another embodiment of the present invention, the Bi—In—Sn—Hg compound is disposed near both of the electrodes, which comprises a bismuth content in the range of 61.1 wt % to 67.1 wt %, an indium content in the range of 23.0 wt % to 29.0 wt %, a stannum content in the range of 4.2 wt % to 5.4 wt %, and a mercury content in the range of 4.0 wt % to 5.0 wt %.

According to still another embodiment of the present invention, the Bi—In—Sn—Hg compound is disposed near both of the electrodes, which comprises a bismuth content in the range of 61.1 wt % to 67.1 wt %, an indium content in the range of 23.0 wt % to 29.0 wt %, a stannum content in the range of 2.9 wt % to 4.1 wt %, and a mercury content in the range of 8.5 wt % to 9.5 wt %.

According to yet still another embodiment of the present invention, the Bi—In—Sn—Hg compound is disposed near both of the electrodes, which comprises a bismuth content in the range of 61.1 wt % to 67.1 wt %, an indium content in the range of 23.0 wt % to 29.0 wt %, a stannum content in the range of 4.2 wt % to 5.4 wt %, and a mercury content in the range of 9.5 wt % to 10.5 wt %.

According to another embodiment of the present invention, the Bi—In—Sn—Hg compound is disposed near one of the electrodes and comprises a bismuth content in the range of 61.1 wt % to 67.1 wt %, an indium content in the range of 23.0 wt % to 29.0 wt %, a stannum content in the range of 2.9 wt % to 4.1 wt %, and a mercury content in the range of 8.5 wt % to 9.5 wt %; and the Bi—In—Sn compound is disposed near another one of the electrodes and comprises a bismuth content in the range of 66.5 wt % to 76.5 wt %, an indium content in the range of 21.0 wt % to 25.0 wt %, a stannum content in the range of 5.0 wt % to 6.0 wt %.

According to another embodiment of the present invention, the Bi—In—Sn—Hg compound is disposed near one of the electrodes and comprises a bismuth content in the range of 61.1 wt % to 67.1 wt %, an indium content in the range of 23.0 wt % to 29.0 wt %, a stannum content in the range of 4.2 wt % to 5.4 wt %, and a mercury content in the range of 9.5 wt % to 10.5 wt %; and the Bi—In—Sn compound is disposed near another one of the electrodes and comprises a bismuth content in the range of 66.5 wt % to 76.5 wt %, an indium content in the range of 21.0 wt % to 25.0 wt %, a stannum content in the range of 5.0 wt % to 6.0 wt %.

According to another embodiment of the present invention, the Bi—In—Sn—Hg compound is disposed near one of the electrodes and comprises a bismuth content in the range of 57.5 wt % to 63.5 wt %, an indium content in the range of 27.0 wt % to 33.0 wt %, a stannum content in the range of 4.4 wt % to 5.6 wt %, and a mercury content in the range of 4.0 wt % to 5.0 wt %; and the Bi—In—Sn compound is disposed near another one of the electrodes and comprises a bismuth content in the range of 66.5 wt % to 76.5 wt %, an indium content in the range of 21.0 wt % to 25.0 wt %, a stannum content in the range of 5.0 wt % to 6.0 wt %.

According to another embodiment of the present invention, the Bi—In—Sn—Hg compound is disposed near one of the electrodes and comprises a bismuth content in the range of 61.1 wt % to 67.1 wt %, an indium content in the range of 23.0 wt % to 29.0 wt %, a stannum content in the range of 4.2 wt % to 5.4 wt %, and a mercury content in the range of 4.0 wt % to 5.0 wt %; and the Bi—In—Sn compound is disposed near another one of the electrodes and comprises a bismuth content in the range of 66.5 wt % to 76.5 wt %, an indium content in the range of 21.0 wt % to 25.0 wt %, a stannum content in the range of 5.0 wt % to 6.0 wt %.

Accordingly, the present invention allows the mercury vapor pressure to rise quickly during the start up of lighting as the dedicated Bi—In—Sn—Hg compound and/or Bi—In—Sn compound could facilitate the faster release of mercury during the time period.

### BRIEF DESCRIPTION OF THE DRAWINGS

The present invention will be described in more detail based on the following description of merely exemplary embodiments with reference to the accompanying drawings, in which:

FIGS. 1-4 illustrate embodiments of the present invention being employed in a fluorescent lamp Model GSU111; and

FIGS. 5-7 illustrate embodiments of the present invention being employed in a fluorescent lamp Model GA607.

### DETAILED DESCRIPTION OF THE PREFERRED EMBODIMENTS

### Example 1

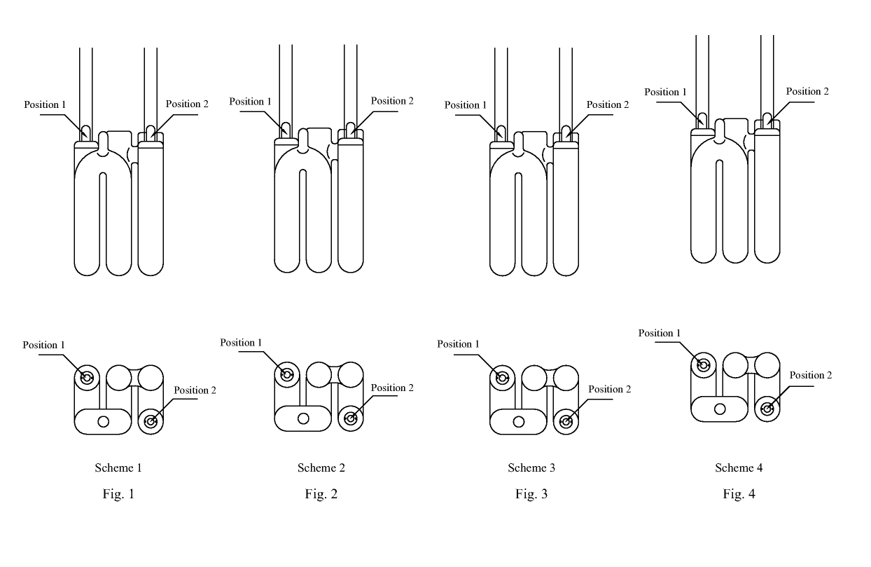

Referring to FIG. 1, it will be seen that, for a fluorescent lamp Model GSU111, an amalgam D might be disposed in a traditional manner at a position near the electrode, i.e., at a position 1 or 2, where the temperature can easily raise. The amalgam D comprises a bismuth-indium-stannum-mercury compound having a bismuth content (Bi) in the range between 57.5 and 63.5 wt. %, an indium content (In) in the range between 27.0 and 33.0 wt. %, a stannum content (Sn) in the range between 4.4 and 5.6 wt. %, and a mercury content (Hg) in the range between 4.0 and 5.0 wt. %.

According to the present invention, the Bi—In—Sn—Hg amalgam D enables, in nominal operation, at least 60% of the rated light output or full brightness of the low-pressure discharge lamp to be reached at about 82 seconds and 7.80% of the rated light output of the lamp to be achieved at 4 seconds after ignition of the lamp.

### Example 2

Referring to FIG. 2, it will be seen that, for a fluorescent lamp Model GSU111, an amalgam A is disposed at positions 1 & 2. The amalgam A comprises a Bi—In—Sn—Hg compound having a Bi content in the range between 61.1 and 67.1 wt. %, an In content in the range between 23.0 and 29.0 wt. %, a Sn content in the range between 4.2 and 5.4 wt. %, and a Hg content in the range between 4.0 and 5.0 wt. %.

According to the present invention, the Bi—In—Sn—Hg amalgam A enables, in nominal operation, at least 60% of the rated light output or full brightness of the low-pressure discharge lamp to be reached at about 21 seconds and 19.60% of the rated light output of the lamp to be achieved at 4 seconds after ignition of the lamp. It can be seen that the elapsed time for reaching 60% of full brightness is just a quarter of the same in the example 1, while the light output achieved in 4 seconds is about 2.5 times of the same in the previous example.

### Example 3

Referring to FIG. 3, it will be seen that, for a fluorescent lamp Model GSU111, an amalgam B is disposed at a position 2 and an alloy C being free of Hg is disposed at a position 1. The amalgam B comprises a Bi—In—Sn—Hg compound having a Bi content in the range between 61.1 and 67.1 wt. %, an In content in the range between 23.0 and 29.0 wt. %, a Sn content in the range between 2.9 and 4.1 wt. %, and a Hg content in the range between 8.5 and 9.5 wt. %. The alloy C comprises a Bi—In—Sn compound having a Bi content in the range between 66.5 and 76.5 wt. %, an In content in the range between 21.0 and 25.0 wt. %, and a Sn content in the range between 5.0 and 6.0 wt. %.

According to the present invention, the Bi—In—Sn—Hg amalgam B in combination with the alloy C enable, in nominal operation, at least 60% of the rated light output or full brightness of the low-pressure discharge lamp to be reached at about 31 seconds and 15.69% of the rated light output of the lamp to be achieved at 4 seconds after ignition of the lamp.

### Example 4

Referring to FIG. 4, it will be seen that, for a fluorescent lamp Model GSU111, an amalgam E is disposed at a position 2 and an alloy C being free of Hg is disposed at a position 1. The amalgam E comprises a Bi—In—Sn—Hg compound having a Bi content in the range between 61.1 and 67.1 wt. %, an In content in the range between 23.0 and 29.0 wt. %, a Sn content in the range between 4.2 and 5.4 wt. %, and a Hg content in the range between 9.5 and 10.5 wt. %. The alloy C comprises a Bi—In—Sn compound having a Bi content in the range between 66.5 and 76.5 wt. %, an In content in the range between 21.0 and 25.0 wt. %, and a Sn content in the range between 5.0 and 6.0 wt. %.

According to the present invention, the Bi—In—Sn—Hg amalgam E in combination with the alloy C enable, in nominal operation, at least 60% of the rated light output or full brightness of the low-pressure discharge lamp to be reached at about 36 seconds and 15.82% of the rated light output of the lamp to be achieved at 4 seconds after ignition of the lamp.

### Example 5

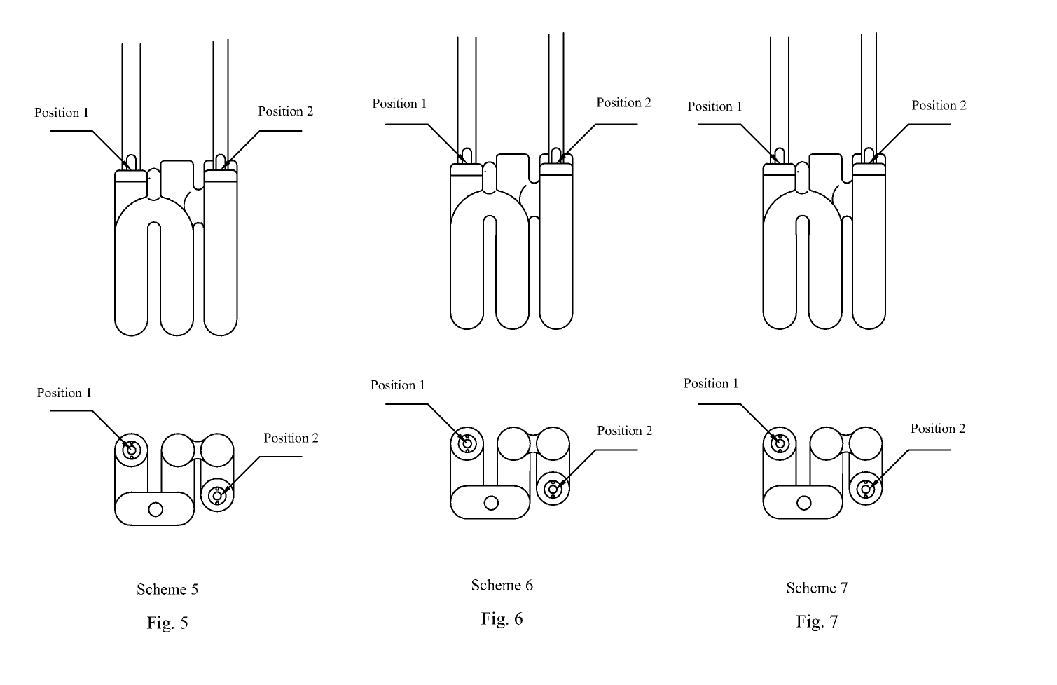

Referring to FIG. 5, it will be seen that, for a fluorescent lamp Model GA607, the amalgam A is disposed in a tradition manner at a position near the electrode, i.e., a position 1 or 2, where the temperature can easily raise.

According to the present invention, the Bi—In—Sn—Hg amalgam A enables, in nominal operation, at least 60% of the rated light output or full brightness of the low-pressure discharge lamp to be reached at about 38 seconds and 15.72% of the rated light output of the lamp to be achieved at 4 seconds after ignition of the lamp.

### Example 6

Referring to FIG. 6, it will be seen that, for a fluorescent lamp Model GA607, the amalgam A is disposed at both position 1 and position 2.

According to the present invention, the Bi—In—Sn—Hg amalgam A enables, in nominal operation, at least 60% of the rated light output or full brightness of the low-pressure discharge lamp to be reached at about 26.4 seconds and 18.28% of the rated light output of the lamp to be achieved at 4 seconds after ignition of the lamp.

### Example 7

Referring to FIG. 7, it will be seen that, for a fluorescent lamp Model GA607, the amalgam B is disposed at a position 2 and the alloy C being free of Hg is disposed at a position 1.

According to the present invention, the Bi—In—Sn—Hg amalgam B in combination with the alloy C enable, in nominal operation, at least 60% of the rated light output of the low-pressure discharge lamp to be reached at about 26 seconds and 19.47% of the rated light output of the lamp to be achieved at 4 seconds after ignition of the lamp.

It should be understood that the alloy C could be used in combination with the amalgams A, B, D, E and disposed near respective electrodes as required, and the starting time and other light output parameters for each of the combination will not be provided herein.

As can be seen, the present invention is able to satisfactorily solve the problems in the prior art. This could be due to the fact that such a fluorescent lamp use an amalgam for controlling the pressure of the mercury vapor in the envelope within an appropriate range during the time that the lamp is lit under normal conditions and an auxiliary amalgam or an alloy for absorbing mercury floating in the envelope when the lamp is turned off and releasing the absorbed mercury during the early stage of lighting, including the moment when the lighting is initiated, such that the mercury vapor pressure could be increased quickly in the early stage of ignition to shorten substantially the starting time of the lamp.

It is obvious that amalgams of compositions in accordance with the present invention or such amalgams in combination with the alloy C being free of Hg are particularly suitable for use in all low-pressure discharge lamps including fluorescent lamps, compact fluorescent lamps, and etc. Put concretely, the technical solution of the present invention could not only be used in GSU111/GA607 type fluorescent lamps, but also in other models well known in the art, such as the lamps having its tube portion in a form selected from a group consisting of linear type, U-type, II-type, H-type, Buddha's Hand-type, W-type, SL-type, and spiral type of lamp tube.

When such improved lamps are used regularly, the lamps will have a comparatively high initial radiation output and a very short starting time as well as a comparatively high radiation output in a comparatively large ambient temperature range.

While preferred embodiments of the present invention have been described with reference to the accompanying drawings, it is to be understood that the embodiments described hereinbefore are illustrative only, and various alterations and modifications are deemed readily apparent and obvious to one skilled in the art.

What is claimed is:

1. A quick-start type fluorescent lamp comprising:
a discharge envelope, which encloses a discharge space containing a filing of mercury and an inert gas in a gastight manner and includes tubular end portions each having a longitudinal axis, and electrodes being arranged in the discharge space for generating and maintaining a discharge therein, characterized in that:
a bismuth-indium-stannum-mercury compound or a bismuth-indium-stannum-mercury compound in combination with a bismuth-indium-stannum compound being free of mercury is disposed at one or two positions near the electrodes.

2. A quick-start type fluorescent lamp as claimed in claim 1, wherein the bismuth-indium-stannum-mercury compound is disposed near both of the electrodes, which comprises a bismuth content in the range of 57.5 wt % to 63.5 wt %, an indium content in the range of 27.0 wt % to 33.0 wt %, a stannum content in the range of 4.4 wt % to 5.6 wt %, and a mercury content in the range of 4.0 wt % to 5.0 wt %.

3. A quick-start type fluorescent lamp as claimed in claim 1, wherein the bismuth-indium-stannum-mercury compound is disposed near both of the electrodes, which comprises a bismuth content in the range of 61.1 wt % to 67.1 wt %, an indium content in the range of 23.0 wt % to 29.0 wt %, a stannum content in the range of 4.2 wt % to 5.4 wt %, and a mercury content in the range of 4.0 wt % to 5.0 wt %.

4. A quick-start type fluorescent lamp as claimed in claim 1, wherein the bismuth-indium-stannum-mercury compound is disposed near both of the electrodes, which comprises a bismuth content in the range of 61.1 wt % to 67.1 wt %, an indium content in the range of 23.0 wt % to 29.0 wt %, a stannum content in the range of 2.9 wt % to 4.1 wt %, and a mercury content in the range of 8.5 wt % to 9.5 wt %.

5. A quick-start type fluorescent lamp as claimed in claim 1, wherein the bismuth-indium-stannum-mercury compound is disposed near both of the electrodes, which comprises a bismuth content in the range of 61.1 wt % to 67.1 wt %, an indium content in the range of 23.0 wt % to 29.0 wt %, a stannum content in the range of 4.2 wt % to 5.4 wt %, and a mercury content in the range of 9.5 wt % to 10.5 wt %.

6. A quick-start type fluorescent lamp as claimed in claim 1, wherein the bismuth-indium-stannum-mercury compound is disposed near one of the electrodes and comprises a bismuth content in the range of 61.1 wt % to 67.1 wt %, an indium content in the range of 23.0 wt % to 29.0 wt %, a stannum content in the range of 2.9 wt % to 4.1 wt %, and a mercury content in the range of 8.5 wt % to 9.5 wt %; and the bismuth-indium-stannum compound is disposed near another one of the electrodes and comprises a bismuth content in the range of 66.5 wt % to 76.5 wt %, an indium content in the range of 21.0 wt % to 25.0 wt %, a stannum content in the range of 5.0 wt % to 6.0 wt %.

7. A quick-start type fluorescent lamp as claimed in claim 1, wherein the bismuth-indium-stannum-mercury compound is disposed near one of the electrodes and comprises a bismuth content in the range of 61.1 wt % to 67.1 wt %, an indium content in the range of 23.0 wt % to 29.0 wt %, a stannum content in the range of 4.2 wt % to 5.4 wt %, and a mercury content in the range of 9.5 wt % to 10.5 wt %; and the bismuth-indium-stannum compound is disposed near another one of the electrodes and comprises a bismuth content in the range of 66.5 wt % to 76.5 wt %, an indium content in the range of 21.0 wt % to 25.0 wt %, a stannum content in the range of 5.0 wt % to 6.0 wt %.

8. A quick-start type fluorescent lamp as claimed in claim 1, wherein the bismuth-indium-stannum-mercury compound is disposed near one of the electrodes and comprises a bismuth content in the range of 57.5 wt % to 63.5 wt %, an indium content in the range of 27.0 wt % to 33.0 wt %, a stannum content in the range of 4.4 wt % to 5.6 wt %, and a mercury content in the range of 4.0 wt % to 5.0 wt %; and the bismuth-indium-stannum compound is disposed near another one of the electrodes and comprises a bismuth content in the range of 66.5 wt % to 76.5 wt %, an indium content in the range of 21.0 wt % to 25.0 wt %, a stannum content in the range of 5.0 wt % to 6.0 wt %.

9. A quick-start type fluorescent lamp as claimed in claim 1, wherein the bismuth-indium-stannum-mercury compound is disposed near one of the electrodes and comprises a bismuth content in the range of 61.1 wt % to 67.1 wt %, an indium content in the range of 23.0 wt % to 29.0 wt %, a stannum content in the range of 4.2 wt % to 5.4 wt %, and a mercury content in the range of 4.0 wt % to 5.0 wt %; and the bismuth-indium-stannum compound is disposed near another one of the electrodes and comprises a bismuth content in the range of 66.5 wt % to 76.5 wt %, an indium content in the range of 21.0 wt % to 25.0 wt %, a stannum content in the range of 5.0 wt % to 6.0 wt %.

10. A quick-start type fluorescent lamp as claimed in claim 2, wherein the bismuth-indium-stannum-mercury compound comprises 60.5 wt % bismuth, 30.0 wt % indium, 5.0 wt % stannum, and 4.5 wt % mercury.

11. A quick-start type fluorescent lamp as claimed in claim 3, wherein the bismuth-indium-stannum-mercury compound comprises 64.1 wt % bismuth, 26.0 wt % indium, 4.8 wt % stannum, and 4.5 wt % mercury.

12. A quick-start type fluorescent lamp as claimed in claim 4, wherein the bismuth-indium-stannum-mercury compound comprises 64.0 wt % bismuth, 23.5 wt % indium, 3.5 wt % stannum, and 9.0 wt % mercury.

13. A quick-start type fluorescent lamp as claimed in claim 5, wherein the bismuth-indium-stannum-mercury compound comprises 61.7 wt % bismuth, 23.6 wt % indium, 4.7 wt % stannum, and 10.0 wt % mercury.

14. A quick-start type fluorescent lamp as claimed in claim 6, wherein the bismuth-indium-stannum compound comprises 71.5 wt % bismuth, 23.0 wt % indium, 5.5 wt % stannum.

15. A quick-start type fluorescent lamp as claimed in claim 8, wherein the bismuth-indium-stannum-mercury compound comprises 60.5 wt % bismuth, 30.0 wt % indium, 5.0 wt % stannum, and 4.5 wt % mercury.

16. A quick-start type fluorescent lamp as claimed in claim 9, wherein the bismuth-indium-stannum-mercury compound comprises 64.1 wt % bismuth, 26.0 wt % indium, 4.8 wt % stannum, and 4.5 wt % mercury.

17. A quick-start type fluorescent lamp as claimed in claim 6, wherein the bismuth-indium-stannum-mercury compound comprises 64.0 wt % bismuth, 23.5 wt % indium, 3.5 wt % stannum, and 9.0 wt % mercury.

18. A quick-start type fluorescent lamp as claimed in claim 7, wherein the bismuth-indium-stannum-mercury compound comprises 61.7 wt % bismuth, 23.6 wt % indium, 4.7 wt % stannum, and 10.0 wt % mercury.

19. A quick-start type fluorescent lamp as claimed in claim 7, wherein the bismuth-indium-stannum compound comprises 71.5 wt % bismuth, 23.0 wt % indium, 5.5 wt % stannum.

20. A quick-start type fluorescent lamp as claimed in claim 9, wherein the bismuth-indium-stannum compound comprises 71.5 wt % bismuth, 23.0 wt % indium, 5.5 wt % stannum.
